(19) United States
(12) Patent Application Publication
(10) Pub. No.: US 2024/0385429 A1
(43) Pub. Date: Nov. 21, 2024

(54) OPTICAL MODULATION DEVICE AND LIGHT FOCUSING DEVICE

(71) Applicants: NATIONAL UNIVERSITY CORPORATION HOKKAIDO UNIVERSITY, Hokkaido (JP); KOREA ADVANCED INSTITUTE OF SCIENCE AND TECHNOLOGY, Daejeon (KR)

(72) Inventors: Atsushi SHIBUKAWA, Hokkaido (JP); Yuki SUDO, Okayama (JP); Jang MOOSEOK, Daejeon (KR)

(21) Appl. No.: 18/693,295

(22) PCT Filed: Sep. 21, 2022
(86) PCT No.: PCT/JP2022/035081

§ 371 Date: Mar. 19, 2024

(30) Foreign Application Priority Data
Sep. 22, 2021 (JP) 2021-153788

(51) Int. Cl. G02B 26/10; G02B 26/08

(52) U.S. Cl. CPC G02B 26/101; G02B 26/0816; G02B 26/0875

(57) ABSTRACT

Provided is a spatial light modulation device which can be driven at a frame rate higher than that of a two-dimensional light modulator. A spatial light modulation device (10) includes a two-dimensional light modulator (11) including a cell group (C) in which cells are arranged in a matrix manner, and a scanning optical system (cylindrical lens 14, scanning mirror 16, objective lens 17). The scanning optical system repeatedly carries out a first conversion step (S11) of converting a two-dimensional beam (L21) into a one-dimensional beam (L11), a modulation step (S12) of generating a spatially modulated one-dimensional beam (L12), and a second conversion step (S13) of converting the modulated one-dimensional beam (L12) into a two-dimensional beam (L22), while changing a column of the cell group (C) which the one-dimensional beam (L11) is caused to enter in the modulation step (S12).

### TECHNICAL FIELD

The present invention relates to a spatial light modulation device, and a light focusing device including the spatial light modulation device.

### BACKGROUND ART

As a spatial light modulator (SLM) that is provided in a spatial light modulation device which spatially (specifically, two-dimensionally) modulates light, a liquid crystal display (LCD), a liquid crystal on silicon (LCOS) display, and a digital mirror device (DMD) are known. These SLMs each include a cell group in which cells are arranged in a matrix manner, and modulation amounts of the respective cells are independently settable. These SLMs each reflect or transmit, at each cell, a two-dimensional beam entering the cell group, and thus modulate the two-dimensional beam in accordance with a modulation amount in each cell.

### CITATION LIST

### Non-Patent Literature

[Non-Patent Literature 1]

Abbas Kazemipour et. al., “Kilohertz frame-rate two-photon tomography”, Nature Methods, VOL 16 778, p. 778, August 2019.

[Non-Patent Literature 2]

Samuel J. Yang et. al., “Extended field-of-view and increased-signal 3D holographic illumination with time-division multiplexing”, OPTICS EXPRESS, Vol. 23, No. 25, p. 32573, 14 Dec. 2015.

[Non-Patent Literature 3]

Donald B. Conkey et. al., “Genetic algorithm optimization for focusing through turbid media in noisy environments”, OPTICS EXPRESS, Vol. 20, No. 5, p. 4840, 27 Feb. 2012.

### SUMMARY OF INVENTION

### Technical Problem

However, in the SLM as described above, a cycle in which a modulation pattern is updated is limited by a frame rate of the LCD, the LCOS, or the DMD that is provided in the SLM. Examples of the frame rate in the LCD are 1 kHz (see Non-Patent Literature 1) and approximately 100 Hz (see Non-Patent Literature 2). An example of the frame rate in the DMD is 25 kHz (see Non-Patent Literature 3). Hereinafter, the LCD and the LCOS are collectively referred to as a liquid crystal spatial light modulator (LC-SLM).

As such, in a case where any of the LC-SLM and the DMD is employed as an SLM provided in a spatial light modulation device, a frame rate of the spatial light modulation device cannot be increased higher than that of the SLM.

An aspect of the present invention is accomplished in view of the above problem, and its object is to provide a spatial light modulation device that can be driven at a frame rate higher than that of an SLM, and to provide a light focusing device that includes such a spatial light modulation device.

### Solution to Problem

In order to attain the object, a spatial light modulation device in accordance with an aspect of the present invention includes: a two-dimensional light modulator that includes a cell group in which cells are arranged in a matrix manner and modulation amounts of the respective cells are independently settable; and a scanning optical system that repeatedly carries out a first conversion step, a modulation step, and a second conversion step while changing a column of the cell group which a one-dimensional beam is caused to enter in the modulation step, the first conversion step being a step of converting a two-dimensional beam into a one-dimensional beam, the modulation step being a step of causing the one-dimensional beam obtained in the first conversion step to enter any of columns of the cell group to generate a one-dimensional beam which is spatially modulated in that column, and the second conversion step being a step of converting the one-dimensional beam obtained in the modulation step into a two-dimensional beam.

A light focusing device in accordance with an aspect of the present invention includes: the above described spatial light modulation device in accordance with an aspect of the present invention; and a scattering medium that converts the two-dimensional beam obtained in the second conversion step into a focused light beam. In this light focusing device, modulation amounts of respective cells are set so that a position at which a focusing point of the focused light beam is formed varies for each of the columns of the cell group.

A light modulation method in accordance with an aspect of the present invention is a light modulation method using a two-dimensional light modulator that includes a cell group in which cells are arranged in a matrix manner and modulation amounts of the respective cells are independently settable. In the light modulation method, a first conversion step, a modulation step, and a second conversion step are repeatedly carried out while changing a column of the cell group which a one-dimensional beam is caused to enter in the modulation step. In this light modulation method, the first conversion step is a step of converting a two-dimensional beam into a one-dimensional beam, the modulation step is a step of causing the one-dimensional beam obtained in the first conversion step to enter any of columns of the cell group to generate a one-dimensional beam which is spatially modulated in that column, and the second conversion step is a step of converting the one-dimensional beam obtained in the modulation step into a two-dimensional beam.

### Advantageous Effects of Invention

According to an aspect of the present invention, it is possible to provide a spatial light modulation device that can be driven at a frame rate higher than that of an SLM, and to provide a light focusing device that includes such a spatial light modulation device.

### BRIEF DESCRIPTION OF DRAWINGS

FIG. 1 is a perspective view illustrating a concept of a light focusing device in accordance with an embodiment of the present invention.

FIG. 2 is a plan view illustrating a two-dimensional light modulator which is provided in a spatial light modulation device included in the light focusing device illustrated in FIG. 1.

FIG. 3 is a perspective view illustrating a concept of a scanning optical system which is provided in a variation of the light focusing device illustrated in FIG. 1.

FIG. 4 is a plan view schematically illustrating a configuration in Example 1 of the present invention.

(a) and (b) of FIG. 5 are plan views schematically illustrating respective configurations of Example 2 and Example 3 of the present invention.

(a) of FIG. 6 is an image indicating distributions φ{φ_{N},φ₂, . . . φₙ, . . . φ_{N}} used in Example 3. (b) of FIG. 6 is an image indicating a modulation pattern of a modulated two-dimensional beam obtained in Example 3. (c) of FIG. 6 is a graph indicating, in a matrix form, a cross-correlation between all distributions φ₁, φ₂, . . . φₙ, . . . φ_{N} in distributions φ{φ₁,φ₂, . . . φₙ, . . . φ_{N}} which were used in Example 3 and in which φₙ is the same. (d) of FIG. 6 is an image indicating a speckle pattern obtained in Comparative Example. (e) of FIG. 6 is an image indicating a focusing point obtained in Example 1.

(a) of FIG. 7 is a graph indicating column dependency of a frame rate in a light focusing device 1 of Example 1 and Example 2. (b) through (d) of FIG. 7 are images indicating focusing points generated when frame rates were set to 1 MHz, 3 MHz, and 6 MHz in Example 1. (e) through (g) of FIG. 7 are images indicating focusing points generated when frame rates were set to 1 MHz, 3 MHz, and 6 MHz in Example 2.

### DESCRIPTION OF EMBODIMENTS

### Overview of Light Focusing Device

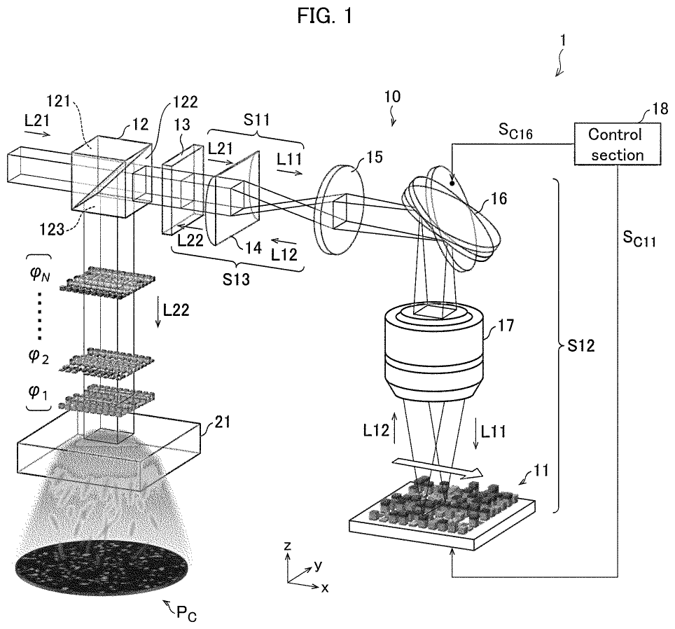

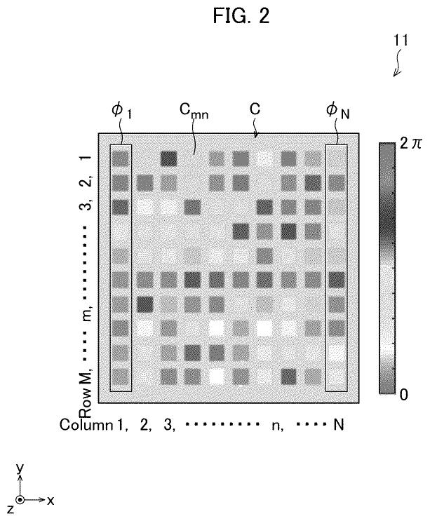

The following description will discuss a light focusing device 1 in accordance with an embodiment of the present invention, with reference to FIGS. 1 and 2. FIG. 1 is a perspective view illustrating a concept of the light focusing device 1. FIG. 2 is a plan view illustrating a two-dimensional light modulator 11 which is provided in a spatial light modulation device 10 included in the light focusing device 1.

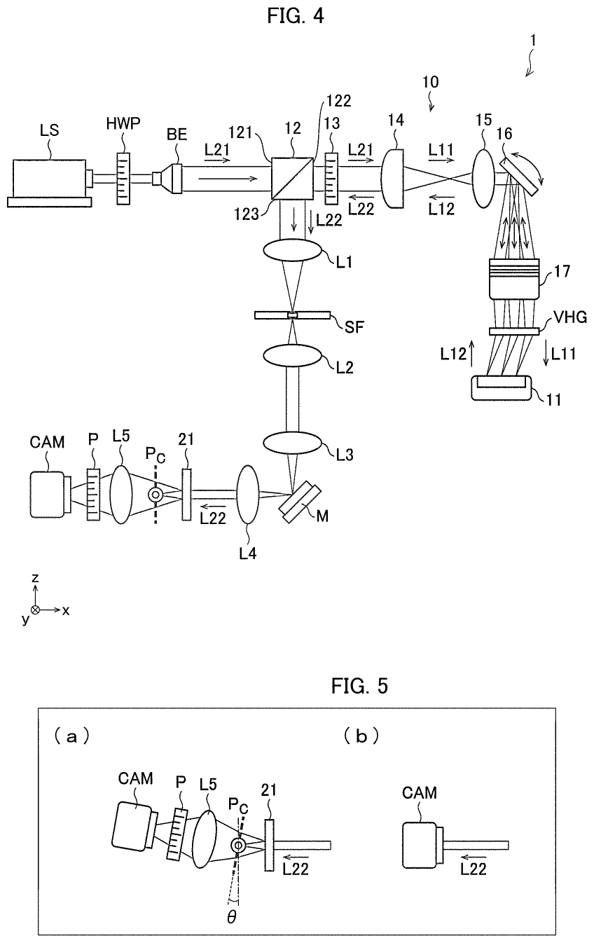

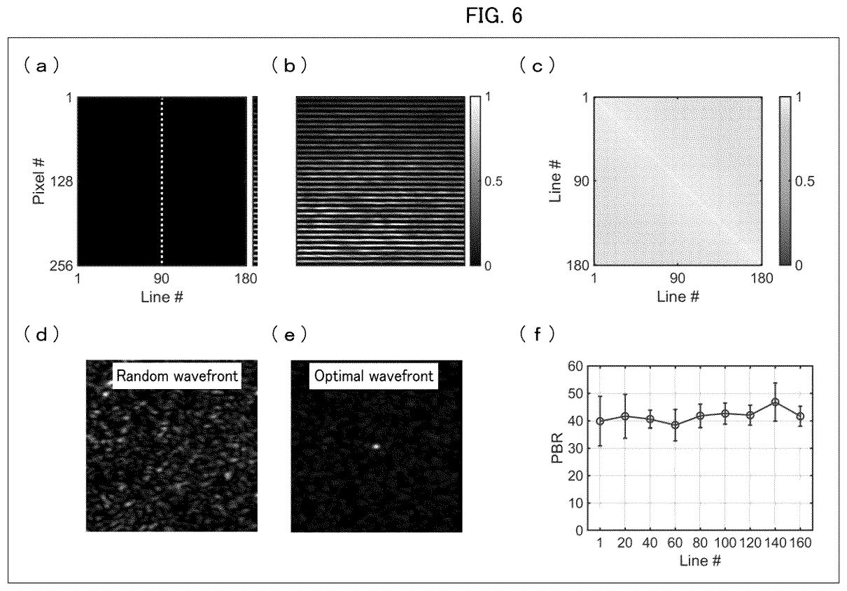

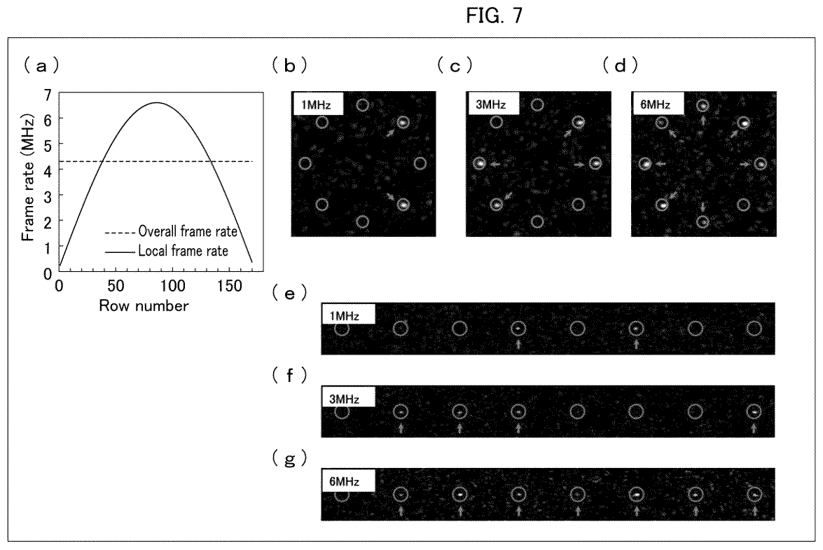

As illustrated in FIG. 1, the light focusing device 1 includes the spatial light modulation device 10 and a scattering medium 21. Note that the following description will discuss a concept of the light focusing device 1. For example, as in Examples of the light focusing device 1 which will be described later with reference to FIGS. 4 and 5, the light focusing device 1 may include a member(s) other than those described in this section of overview.

### —Spatial Light Modulation Device

The spatial light modulation device 10 illustrated in FIG. 1 is an embodiment of the present invention. The spatial light modulation device 10 includes a two-dimensional light modulator 11, a polarized beam splitter 12, a quarter-wave plate 13, a cylindrical lens 14, a biconvex lens 15, a scanning mirror 16, an objective lens 17, and a control section 18.

### Two-Dimensional Light Modulator

The two-dimensional light modulator 11 is also called a spatial light modulator (SLM). As illustrated in FIG. 2, the two-dimensional light modulator 11 includes a cell group C in which a plurality of cells Cₘₙ are arranged in a matrix manner, and modulation amounts of the respective cells Cₘₙ are independently settable. In the present embodiment, the cell group C is constituted by cells Cₘₙ which are arranged in M rows and N columns. Here, M and N are each an integer of 1 or more, m is an integer of 1≤m≤M, and n is an integer of 1≤n≤N. In the present embodiment, for example, M and N are each 200. Note, however, that M and N are not limited to 200, and can be set as appropriate. In the present embodiment, a square matrix in which M=N is used as an arrangement of the cells Cₘₙ of the cell group C. Note, however, that, in regard to the cells Cₘₙ of the cell group C, the number of rows M may differ from the number of columns N. A one-dimensional beam L11 (described later) may be moved throughout an entire region of the cells Cₘₙ arranged in the M rows and N columns. Alternatively, the one-dimensional beam L11 may be moved in only a partial region of the cells Cₘₙ arranged in the M rows and N columns.

In the spatial light modulation device 10, a reflective type two-dimensional light modulator 11 is used. Therefore, as the two-dimensional light modulator 11, either a liquid crystal on silicon (LCOS) display or a digital mirror device (DMD) can be suitably used. The LCOS, which is an example of the liquid crystal spatial light modulator, can modulate a phase of entered light in accordance with set modulation amounts (e.g., 0 n or more and 2 n or less) of the cells Cₘₙ. The DMD can modulate an intensity of entered light in accordance with set modulation amounts (e.g., 0 or 1) of the cells Cₘₙ. Therefore, the cell group C in which such cells Cₘₙare arranged in a matrix manner can reflect entered light and thus convert the entered light into spatially modulated light.

A frame rate of the LCOS which can be driven at high speed is, for example, 500 Hz. A frame rate of the DMD which can be driven at high speed is, for example, 25 kHz. In the present embodiment, a DMD having a frame rate of 25 kHz is used as the two-dimensional light modulator 11.

The two-dimensional light modulator 11 is controlled by the control section 18. The control section 18 resets, for each frame, the modulation amounts of the respective cells Cₘₙ of the two-dimensional light modulator 11.

In FIG. 2, a direction along the row of the cell group C is defined as an x-axis direction, a direction along the column is defined as a y-axis direction, and a direction that constitutes a right-handed orthogonal coordinate system together with the x-axis direction and the y-axis direction is defined as a z-axis direction. The coordinate system illustrated in FIG. 1 is the same as the coordinate system illustrated in FIG. 2.

### Laser Light Source

In the present embodiment, a HeNe laser is used as a laser light source that generates a two-dimensional beam L21. Therefore, a wavelength of the two-dimensional beam L21 is 632.8 nm. Note, however, that the laser light source that generates the two-dimensional beam L21 and the wavelength of the two-dimensional beam L21 are not limited to those examples, and can be selected as appropriate.

Although the laser light source is not illustrated in FIG. 1, the laser light source is arranged so that a propagation direction of the two-dimensional beam L21 is parallel to a positive direction of the x axis. That is, an optical axis of the two-dimensional beam L21 is parallel to the x-axis direction.

The two-dimensional beam L21 is linear polarized light whose plane of polarization is parallel to a zx plane. As illustrated in FIG. 1, the two-dimensional beam L21 is adjusted to be collimated light whose irradiation region is in a square shape.

### Polarized Beam Splitter

The polarized beam splitter 12 is a cubic optical member which is constituted by joining two prisms together. As illustrated in FIG. 1, the polarized beam splitter 12 is disposed on the optical axis of the two-dimensional beam L21. Hereinafter, among six surfaces constituting the polarized beam splitter 12, a surface (surface on the negative direction side of the x axis) which the two-dimensional beam L21 enters is referred to as a surface 121, a surface (surface on the positive direction side of the x axis) from which the two-dimensional beam L21 exits and which a two-dimensional beam L22 enters is referred to as a surface 122, and a surface (surface on the negative direction side of the z axis) from which the two-dimensional beam L22 exits is referred to as a surface 123.

A composition face in the polarized beam splitter 12 allows linear polarized light whose plane of polarization is parallel to the zx plane to pass therethrough, and also reflects linear polarized light whose plane of polarization is parallel to an xy plane. Therefore, the composition face in the polarized beam splitter 12 allows the two-dimensional beam L21 to pass therethrough. The two-dimensional beam L21 which has passed through the polarized beam splitter 12 is converted, in the quarter-wave plate 13 (described later), from linear polarized light whose plane of polarization is parallel to the zx plane into circularly polarized light. Moreover, the two-dimensional beam L22 is converted, in the quarter-wave plate 13, from circularly polarized light into linear polarized light whose plane of polarization is parallel to the xy plane. Therefore, the composition face in the polarized beam splitter 12 reflects, toward the surface 123, the two-dimensional beam L22 which has entered from the surface 122. Note that the two-dimensional beam L22 is collimated light whose irradiation region is in a square shape, as with the two-dimensional beam L21. A configuration and a method for converting the two-dimensional beam L21 into the two-dimensional beam L22 will be described later.

In the present embodiment, the polarized beam splitter 12 which is configured as described above emits, from the surface 122, the two-dimensional beam L21 which has entered the surface 121 of the polarized beam splitter 12, and also emits, from the surface 123, the two-dimensional beam L22 which has entered from the surface 122.

In the spatial light modulation device 10, the combination of the polarized beam splitter 12 and the quarter-wave plate 13 can be replaced with a beam splitter (herein referred to as a half mirror) that is not dependent on polarized light. In that case, however, power of the two-dimensional beam L21 is halved when the two-dimensional beam L21 passes through the half mirror, and power of the two-dimensional beam L22 is halved when the two-dimensional beam L22 is reflected by the half mirror. Therefore, in a case where the half mirror is used, a loss increases as compared with a case where the combination of the polarized beam splitter 12 and the quarter-wave plate 13 is used. Therefore, in a case where emphasis is placed on reduction of a loss, the combination of the polarized beam splitter 12 and the quarter-wave plate 13 may be employed. In a case where emphasis is placed on simplicity of the configuration and low component cost, the half mirror may be employed.

### Quarter-Wave Plate

As illustrated in FIG. 1, the quarter-wave plate 13 is disposed on the optical axis of the two-dimensional beam L21. The quarter-wave plate 13 converts the two-dimensional beam L21 from linear polarized light whose plane of polarization is parallel to the zx plane into circularly polarized light. Moreover, the quarter-wave plate 13 converts the two-dimensional beam L22 from circularly polarized light into linear polarized light whose plane of polarization is parallel to the xy plane.

### Cylindrical Lens

As illustrated in FIG. 1, the cylindrical lens 14 is disposed on the optical axis of the two-dimensional beam L21. The cylindrical lens 14 is arranged in an orientation for converting components of the two-dimensional beam L21 in the z-axis direction from collimated light into convergent light and allowing components of the two-dimensional beam L21 in the y-axis direction to pass therethrough as collimated light.

Therefore, the cylindrical lens 14 converts the two-dimensional beam L21 into the one-dimensional beam L11, and also converts a one-dimensional beam L12 into the two-dimensional beam L22. Note that the optical axis of the two-dimensional beam L21 conforms to the optical axis of the one-dimensional beam L11, and the optical axis of the one-dimensional beam L12 conforms to the optical axis of the two-dimensional beam L22.

The one-dimensional beam L11 and the one-dimensional beam L12 are beams each having an irradiation region that is a one-dimensional line in an image forming state. The cylindrical lens 14 is arranged so that a line of the one-dimensional beam L11 which is obtained by converting the two-dimensional beam L21 is parallel to the y axis.

### Biconvex Lens

As illustrated in FIG. 1, the biconvex lens 15 is disposed on the optical axis of the one-dimensional beam L11. The biconvex lens 15 is disposed at a position at which a distance from the cylindrical lens 14 is equal to a sum of a focal length of the cylindrical lens 14 and a focal length of the biconvex lens 15. Therefore, the biconvex lens 15 converts components of the one-dimensional beam L11 in the z-axis direction from diffusion light into collimated light, and converts components of the one-dimensional beam L11 in the y-axis direction from collimated light into convergent light.

### Scanning Mirror

As illustrated in FIG. 1, the scanning mirror 16 is disposed on the optical axis of the one-dimensional beam L11. The scanning mirror 16 is disposed at a position at which a distance between a center of the scanning mirror 16 and the biconvex lens 15 is equal to the focal length of the biconvex lens 15.

The scanning mirror 16 is, at a basic position thereof, arranged so as to reflect, in the negative direction of the z axis, the one-dimensional beam L11 which has been propagated in the positive direction of the x axis. That is, with respect to a reflection surface of the scanning mirror 16 at the basic position, the one-dimensional beam L11 enters at an incident angle of 45° and exits at an exit angle of 45°.

The scanning mirror 16 is, at the basic position thereof, arranged so as to reflect, in the negative direction of the x axis, the one-dimensional beam L12 which has been propagated in the positive direction of the z axis. That is, with respect to the reflection surface of the scanning mirror 16 at the basic position, the one-dimensional beam L12 enters at an incident angle of 45° and exits at an exit angle of 45°.

The scanning mirror 16 is configured such that an orientation of the reflection surface oscillates with respect to the basic position within a very small angle range. Note that the scanning mirror 16 is arranged so that a rotation axis is parallel to the y axis. The angle range in which the scanning mirror 16 oscillates is not limited. The angle range can be set as appropriate in accordance with widths of columns in the cell group C of the two-dimensional light modulator 11, an arrangement of the optical system, and the like. The angle range is, for example, ±2.5° with respect to the basic position.

The scanning mirror 16 changes the orientation of the reflection surface to change a column of the cell group C which the one-dimensional beam L11 is caused to enter in a modulation step S12 (described later).

A column serving as a unit for switching in the cell group C when the one-dimensional beam L11 is caused to enter may be constituted by one column of cells Cₘₙ or may be constituted by a plurality of columns of cells Cₘₙ. The number of columns of cells Cₘₙ which serves as the unit for switching can be set as appropriate while taking into consideration a magnitude relation with a line width of the one-dimensional beam L11, accuracy of alignment in the scanning optical system, and the like.

As such a scanning mirror 16, any of a resonator mirror, a galvanometer mirror, and a polygon mirror can be suitably used. A driving frequency of the resonator mirror which can be driven at high speed is, for example, 12 kHz. A driving frequency of the galvanometer mirror which can be driven at high speed is, for example, 500 Hz. In the present embodiment, a resonator mirror having a driving frequency of 12 kHz is used as the scanning mirror 16.

Operation of the scanning mirror 16 is controlled by the control section 18. Specifically, the control section 18 controls an angle range in which the scanning mirror 16 oscillates.

### Objective Lens

The objective lens 17 is disposed on the optical axis of the one-dimensional beam L11 which has been reflected by the scanning mirror 16. The objective lens 17 is disposed at a position at which a distance from the center of the scanning mirror 16 is equal to a focal length of the objective lens 17. Therefore, the objective lens 17 converts components of the one-dimensional beam L11 in the y-axis direction from diffusion light into collimated light, and converts components of the one-dimensional beam L11 in the x-axis direction from collimated light into convergent light. The two-dimensional light modulator 11, which is disposed downstream of the objective lens 17, is disposed at a position at which a distance from the objective lens 17 is equal to the focal length of the objective lens 17. Therefore, components of the one-dimensional beam L11 in the x-axis direction form an image on a surface of the two-dimensional light modulator 11, and thus an irradiation region becomes a one-dimensional line. A direction in which the line of the one-dimensional beam L11 extends is parallel to the column direction (i.e., y direction) of the cell group C.

As such, the objective lens 17 guides the one-dimensional beam L11 which has been reflected by the scanning mirror 16 to any of columns of the cell group C to form an image. At this time, a column of the cell group C in which the one-dimensional beam L11 forms an image is controlled by the orientation of the reflection surface of the scanning mirror 16. That is, a column of the cell group C in which an image is formed by the one-dimensional beam L11 is controlled by the control section 18.

### Combination of Biconvex Lens and Objective Lens

The objective lens 17 forms an image, on the reflection surface of the scanning mirror 16, with the one-dimensional beam L12 which has been reflected by any of the columns of the cell group C and which has been spatially modulated. The one-dimensional beam L12 propagates in the same optical path as that of the one-dimensional beam L11 in an opposite direction and enters the cylindrical lens 14.

The objective lens 17 cooperates with the biconvex lens 15 to two-dimensionally reduce or enlarge sizes of the one-dimensional beam L11 and the one-dimensional beam L12 which are line beams. A magnification of reduction or enlargement by the biconvex lens 15 and the objective lens 17 is determined based on a combination of the focal length of the biconvex lens 15 and the focal length of the objective lens 17.

In a case where an aberration caused by scanning using the scanning mirror 16 can be tolerated to some extent, the biconvex lens 15 and the objective lens 17 can be omitted. In such a case, the cylindrical lens 14 is disposed at the position of the objective lens 17 in FIG. 1, and the scanning mirror 16 and the two-dimensional light modulator 11 are arranged in front and behind the cylindrical lens 14, respectively. At this time, a distance between the cylindrical lens 14 and the scanning mirror 16 and a distance between the cylindrical lens 14 and the two-dimensional light modulator 11 are equal to the focal length of the cylindrical lens 14. An example of a case in which an aberration caused by scanning using the scanning mirror 16 can be tolerated to some extent includes a case in which only columns in the vicinity of the center of the two-dimensional light modulator 11 are used. That is, the example case can be a case in which a scanning range of the one-dimensional beam L11 in the column direction is narrow. In the present embodiment, the two-dimensional light modulator 11 having 200 columns is used. Therefore, the center of the two-dimensional light modulator 11 is located between the 100th column and the 101st column.

### Scanning Optical System

Among the above described two-dimensional light modulator 11, polarized beam splitter 12, cylindrical lens 14, biconvex lens 15, scanning mirror 16, objective lens 17, and control section 18, the cylindrical lens 14, the scanning mirror 16, and the objective lens 17 are examples of a scanning optical system.

### Light Modulation Method

Next, a light modulation method which is carried out by the spatial light modulation device 10 will be described with reference to FIG. 1.

This light modulation method includes a first conversion step S11, a modulation step S12, and a second conversion step S13.

First, the cylindrical lens 14 of the scanning optical system carries out the first conversion step S11 of converting a two-dimensional beam L21 into a one-dimensional beam L11.

Next, the scanning mirror 16 and the objective lens 17 of the scanning optical system carries out the modulation step S12 of causing the one-dimensional beam L11 obtained in the first conversion step S11 to enter any of columns of the cell group C so as to generate a one-dimensional beam L12 which is spatially modulated by that column.

Next, the objective lens 17 and the scanning mirror 16 of the scanning optical system cause the spatially modulated one-dimensional beam L12 to enter the cylindrical lens 14.

Next, the cylindrical lens 14 of the scanning optical system carries out the second conversion step S13 of converting the spatially modulated one-dimensional beam L12 into a two-dimensional beam L22.

Furthermore, in the present light modulation method, the above steps are repeatedly carried out while changing a column of the cell group C which the one-dimensional beam L11 is caused to enter in the modulation step S12.

As described above, in the spatial light modulation device 10, the one-dimensional beam L11 is caused to enter any of the columns of the cell group C to generate a spatially modulated one-dimensional beam L12, and the spatially modulated one-dimensional beam L12 is converted into a two-dimensional beam L22, and thus the spatially modulated two-dimensional beam L22 can be generated. Therefore, it is possible to obtain a maximum of N modulation patterns without resetting the modulation amount (i.e., without updating a frame) in each of the cells Cₘₙ in the two-dimensional light modulator 11. Thus, the spatial light modulation device 10 can be driven at a frame rate higher than that of the two-dimensional light modulator 11.

### Control by Control Section

The control section 18 sets modulation amounts of the respective cells Cₘₙ in the cell group C in advance. The modulation amount set in advance is referred to as a 1st frame modulation amount. A distribution of one-dimensional modulation amounts for cells C₁ₙ through C_{Mn} arranged in an n-th column of the cell group C is referred to as a distribution φₙ, and distributions φₙ of the cell group C for one frame is collectively referred to as distributions {φ₁,φ₂, . . . φₙ, . . . φN}. FIG. 2 illustrates, as representatives, distributions φ₁ and φ_{N} among the distributions φ.

Furthermore, the control section 18 controls the scanning mirror 16 to cause the one-dimensional beam L11 to enter cells C₁₁ through C_{M 1} which are arranged in the 1st column of the cell group C. The cells C₁₁ through C_{M 1} modulate the one-dimensional beam L11 with a distribution φ₁ to convert the one-dimensional beam L11 into a one-dimensional beam L12. That is, the one-dimensional beam L12 is a one-dimensional beam which has been spatially modulated by the distribution φ₁.

Next, the control section 18 controls the scanning mirror 16 to cause the one-dimensional beam L11 to enter cells C₁₂ through C_{M2} which are arranged in the 2nd column of the cell group C. The cells C₁₂ through C_{M2} modulate the one-dimensional beam L11 with a distribution φ₂ to convert the one-dimensional beam L11 into a one-dimensional beam L12.

After that, the control section 18 controls the scanning mirror 16 to cause the one-dimensional beam L11 to enter each of the 3rd column through the N-th column of the cell group C in order. The 3rd column through the N-th column of the cell group C modulate the one-dimensional beam L11 with respective distributions φ₃, . . . φₙ, . . . φ_{N} to convert the one-dimensional beam L11 into one-dimensional beams L12.

As described above, the spatial light modulation device 10 moves the one-dimensional beam L11 in the positive direction of the x axis using the scanning mirror 16 and the control section 18, and thus generates one-dimensional beams L12 modulated with the distributions φ{φ₁,φ₂, . . . φₙ, . . . φ_{N}} of the 1st frame modulation amounts of the two-dimensional light modulator 11. That is, in the modulation step S12, the one-dimensional beam L11 is caused to sequentially enter each of all the 1st column to the N-th column of the cell group C, and thus the light-modulation device 10 generates one-dimensional beams L12 having the distributions φ{φ₁,φ₂, . . . φₙ, . . . φ_{N}}.

Note that the one-dimensional beams L12 are converted into two-dimensional beams L22 in the second conversion step S13. Through the second conversion step S13, the distributions φₙ of the one-dimensional beams L12 are extended along the row direction. Consequently, each of the distributions φₙ of the two-dimensional beams L22 has a shape in which each of distributions φₙ of the one-dimensional beams L12 is enlarged along the row direction.

Here, in a case where the number of intended modulation patterns for the one-dimensional beam L11 is equal to or less than the number of columns N, the light modulation method may be ended with the above steps. Meanwhile, in a case where the number of intended modulation patterns is more than the number of columns N, the control section 18 resets the modulation amounts of the respective cells Cₘₙ of the cell group C. The reset modulation amount is referred to as a 2nd frame modulation amount.

The control section 18 controls the scanning mirror 16 to cause the one-dimensional beam L11 to enter each of the Nth column through the 1st column of the cell group C in order. That is, the spatial light modulation device 10 moves the one-dimensional beam L11 in the negative direction of the x axis using the scanning mirror 16 and the control section 18, and thus generates one-dimensional beams L12 modulated with distributions φ{φ_{N+1},φ_{N+2}, . . . φ_{2N}} of the 2nd frame modulation amounts of the two-dimensional light modulator 11. That is, in the modulation step S12, the one-dimensional beam L11 is caused to sequentially enter each of all the N-th column to the 1st column of the cell group C, and thus the light-modulation device 10 generates one-dimensional beams L12 having the distributions φ{φ_{N+1},φ_{N+2}, . . . φ_{2N}}. The one-dimensional beams L12 are converted into two-dimensional beams L22 in the second conversion step S13.

It is preferable that the two-dimensional light modulator 11 can update the modulation amounts of the respective cells Cₘₙ to the 2nd frame modulation amounts as soon as possible at a timing when the one-dimensional beam L11 has been moved from the 1st column to the N-th column of the cell group C. For this purpose, the frame rate of the two-dimensional light modulator 11 is preferably as high as possible, and is more preferably not less than twice the driving frequency of the scanning mirror 16. In the present embodiment, the DMD having a frame rate of 25 kHz is employed as the two-dimensional light modulator 11, and the resonator mirror having a driving frequency of 12 kHz is used as the scanning mirror 16. As such, the above condition is satisfied.

The spatial light modulation device 10 configured as described above can generate two-dimensional beams L22 which have been modulated with the distributions φ{φ₁,φ₂, . . . φₙ, . . . φ_{N}} and the distributions φ{φ_{B+1}φ_{N+1}, . . . φ_{2N}} for two frames of the two-dimensional light modulator 11 while the scanning mirror 16 carries out scanning for one cycle. Therefore, the spatial light modulation device 10 can realize a frame rate of 12 kHz×2×N. In the present embodiment, N=200 is employed. Therefore, the spatial light modulation device 10 can realize a frame rate of 4.8 MHz.

In the present embodiment, an intensity modulation type DMD is employed as the two-dimensional light modulator 11, and a resonator mirror is employed as the scanning mirror 16 in accordance with the frame rate (e.g., 25 kHz) of the DMD. In a case of employing a phase modulation type LCOS as the two-dimensional light modulator 11, however, it is preferable to employ a galvanometer mirror as the scanning mirror 16 in accordance with a frame rate (e.g., 500 Hz) of the LCOS. In a case of employing 250 Hz (which is ½ of the frame rate of LCOS) as a driving frequency of the galvanometer mirror, the spatial light modulation device 10 can realize a frame rate of 100 kHz (=250 Hz×2×N).

### Scattering Medium

As described above, the spatial light modulation device 10 emits, in the negative direction of the z axis, the spatially modulated two-dimensional beam L22 from an exit surface located on the negative direction side of the z axis of the polarized beam splitter 12. FIG. 1 schematically illustrates only the two-dimensional beams L22 which have been modulated with the distributions φ{φ₁,φ₂, . . . φₙ, . . . φ_{N}} of the 1st frame modulation amounts of the two-dimensional light modulator 11. The scanning mirror 16 and the objective lens 17 of the scanning optical system sequentially irradiate the columns of the cell group C with the one-dimensional beam L11. Therefore, the two-dimensional beams L22 which have been modulated by the distributions φ{φ₁,φ₂, . . . φₙ, . . . φ_{N}} are emitted in order from the polarized beam splitter 12.

Furthermore, in the light focusing device 1, the scattering medium 21 is disposed at a position downstream of the spatial light modulation device 10 (i.e., downstream of the polarized beam splitter 12) and serving as a conjugate plane of the two-dimensional light modulator 11.

The scattering medium 21 is configured to scatter light entering one main surface (main surface on the positive direction side of the z axis in FIG. 1). The scattering medium 21 may be a solid, a liquid, or a colloid such as gel. In the present embodiment, ground glass is employed as a solid scattering medium 21. Other examples of the solid scattering medium 21 include opal glass and aggregated nanoparticles.

It is known that, in a case where a two-dimensional beam having a random modulation pattern is caused to enter the scattering medium 21, a plurality of spot-like patterns called speckles occur on a focusing surface Pc which is located downstream of the scattering medium 21. However, the two-dimensional beam can be focused at a predetermined point by obtaining, in advance, a wavefront solution of a two-dimensional beam for a specific scattering medium 21, and approximating a wavefront of a two-dimensional beam L22 generated by the spatial light modulation device 10 as close to the above wavefront solution as possible. For this purpose, it is only necessary to set the modulation amounts of the respective cells Cₘₙ so that the wavefront of the two-dimensional beam L22 is brought as close to the above wavefront solution as possible in each of the columns of the cell group C. In the present embodiment, as a method of obtaining the above wavefront solution, a genetic algorithm (X. Zhang et al., “Binary wavefront optimization using a genetic algorithm” (2019)) is employed which imitates a process in which an organism evolves. Note, however, that a method of obtaining a wavefront solution is not limited to this and can be selected as appropriate.

By thus setting the modulation amounts of the respective cells Cₘₙ, the spatially modulated two-dimensional beams L22 can be focused at a predetermined focusing point using the scattering medium 21.

As such, in each of the columns of the cell group C, by setting the distributions φ{φ₁,φ₂, . . . φₙ, . . . φ_{N}} so that focusing points of the focused light beam are formed at different positions, it is possible to move the focusing point. Therefore, it is possible to carry out scanning type imaging. This technique is called a scattering lens.

For example, by setting, in the light focusing surface P_{C}, distributions φ{φ₁,φ₂, . . . φₙ, . . . φ_{N}} so that the focusing point moves, the light focusing device 1 can move the focusing point along a predetermined path on the light focusing surface P_{C}. By optimizing the distributions φ in the cell group C not only in the 1st frame but also in the 2nd frame and the subsequent frames of the two-dimensional light modulator 11, the light focusing device 1 can move the focusing point on the light focusing surface P_{C} over an intended period.

### Variation

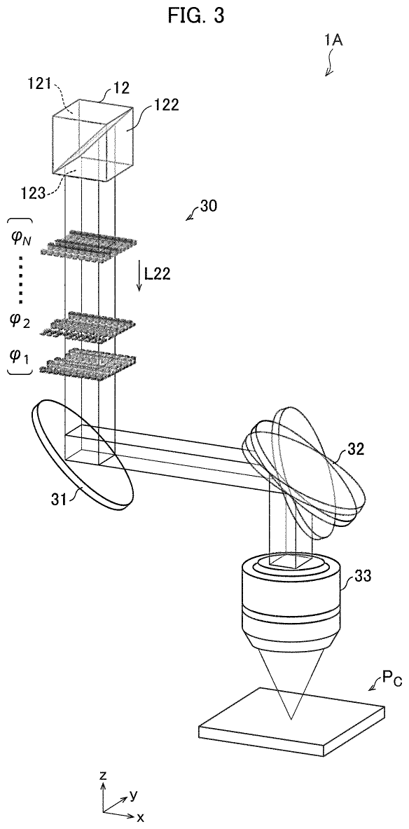

The following description will discuss, with reference to FIG. 3, a light focusing device 1A which is a variation of the light focusing device 1 illustrated in FIG. 1. FIG. 3 is a perspective view illustrating a concept of a scanning optical system 30 which is provided in the light focusing device 1A. A coordinate system illustrated in FIG. 3 is the same as the coordinate system illustrated in FIGS. 1 and 2.

The light focusing device 1A is based on the light focusing device 1. Note, however, that the light focusing device 1A differs from the light focusing device 1 in that the scanning optical system 30 is employed instead of the scattering medium 21 which is disposed downstream of the spatial light modulation device 10 (downstream of the polarized beam splitter 12). Therefore, in this variation, only the scanning optical system 30 will be described, and the description of the spatial light modulation device 10 will be omitted.

As illustrated in FIG. 3, the scanning optical system 30 includes a fixed mirror 31, a scanning mirror 32, and an objective lens 33.

### Fixed Mirror

As illustrated in FIG. 3, the fixed mirror 31 is disposed on the optical axis of the two-dimensional beam L22. The fixed mirror 31 is arranged to reflect, in the positive direction of the x axis, the two-dimensional beam L22 which has been propagated in the negative direction of the z axis. That is, with respect to a reflection surface of the fixed mirror 31, the two-dimensional beam L22 enters at an incident angle of 45° and exits at an exit angle of 45°.

In the present variation, the fixed mirror 31 is provided for convenience in order to cause the optical axis of the two-dimensional beam L22 which has been reflected by the scanning mirror 32 to be parallel to the optical axis of the one-dimensional beam L11 which is emitted toward the two-dimensional light modulator 11 in the spatial light modulation device 10 illustrated in FIG. 1. The fixed mirror 31 can be omitted in a case where the optical axis of the two-dimensional beam L22 which has been reflected by the scanning mirror 32 does not need to be parallel to the optical axis of the one-dimensional beam L11 which is emitted toward the two-dimensional light modulator 11 in the spatial light modulation device 10.

### Scanning Mirror

The scanning mirror 32 is disposed on the optical axis of the two-dimensional beam L22 which has been reflected by the fixed mirror 31.

The scanning mirror 32 is, at a basic position thereof, arranged so as to reflect, in the negative direction of the z axis, the two-dimensional beam L22 which has been propagated in the positive direction of the x axis. That is, with respect to the reflection surface of the scanning mirror 32 at the basic position, the two-dimensional beam L22 enters at an incident angle of 45° and exits at an exit angle of 45°.

The scanning mirror 32 is, as with the scanning mirror 16, configured such that an orientation of the reflection surface oscillates with respect to the basic position within a very small angle range. Note that the scanning mirror 32 is arranged so that a rotation axis is parallel to the y axis.

By including the scanning optical system 30, the light focusing device 1A can move the two-dimensional beam L22 which forms an image on the light focusing surface Pc while periodically oscillating the two-dimensional beam L22 in the x-axis direction.

The two-dimensional light modulator 11 can change, in a time series, stripe-shaped distributions φ{φ₁,φ₂, . . . φₙ, . . . φ_{N}} along the y-axis direction. Therefore, the two-dimensional light modulator 11 can minutely change a propagation angle of the two-dimensional beam L22 along the y-axis direction. Thus, it is possible to move a light spot generated by the objective lens 33 on the light focusing surface Pc along the y-axis direction.

Furthermore, the light focusing device 1A includes the scanning mirror 32. Therefore, propagation angles of the two-dimensional beams L22 having the stripe-shaped distributions φ{φ₁,φ₂, . . . φₙ, . . . φ_{N}} can be minutely changed along the x-axis direction. Thus, it is possible to move a light spot generated by the objective lens 33 on the light focusing surface Pc along the x-axis direction. Therefore, as with the light focusing device 1, the light focusing device 1A can two-dimensionally move the light spot of the two-dimensional beam L22 on the light focusing surface Pc.

### Objective Lens

The objective lens 33 causes the two-dimensional beam L22 which has been reflected by the scanning mirror 32 to form an image at a predetermined light focusing surface Pc. Note that, by employing a convertible lens as the objective lens 33, the focusing point of the two-dimensional beam L22 can be varied along the z-axis direction.

### EXAMPLES

The following description will discuss Example 1, Example 2, and Example 3 of the light focusing device 1, with reference to FIGS. 4 and 5. FIG. 4 is a plan view schematically illustrating a configuration of the light focusing device 1 in Example 1. (a) and (b) of FIG. 5 are plan views schematically illustrating respective configurations of the light focusing device 1 in Example 2 and Example 3.

Examples 1 through 3 are configurations embodying the light focusing device 1 illustrated in FIG. 1 in order to implement aspects of the present invention. Note, however, that the configuration for embodying the light focusing device 1 illustrated in FIG. 1 is not limited to Examples 1 through 3, and optical members other than the polarized beam splitter 12, the cylindrical lens 14, the scanning mirror 16, and the objective lens 17 can be selected as appropriate.

Example 1 is a configuration in which a focusing point of the two-dimensional beam L22 is moved using the light focusing device 1. In FIG. 4, a configuration of an observation system that is disposed downstream of the light focusing surface Pc is a configuration for observing a focusing point that is moved. The configuration of the observation system can be omitted when the light focusing device 1 is actually used.

Example 2 is a configuration in which a focusing point of the two-dimensional beam L22 is moved using the light focusing device 1, and a distance between each focusing point and the scattering medium 21 is changed. (a) of FIG. 5 illustrates only the configuration of the observation system used in Example 2.

Example 3 is a configuration in which a modulation pattern of the two-dimensional beam L22 is observed as it is without converting the two-dimensional beam L22 generated by the light focusing device 1 into a focused light beam. (b) of FIG. 5 illustrates only a configuration of an observation system used in Example 3.

### Example 1

In the light focusing device 1 of Example 1, the spatial light modulation device 10 included, in addition to the configuration of the spatial light modulation device 10 (two-dimensional light modulator 11, polarized beam splitter 12, cylindrical lens 14, biconvex lens 15, scanning mirror 16, objective lens 17, and control section 18) illustrated in FIG. 1, a laser light source LS, a half-wave plate HWP, a beam expander BE, a quarter-wave plate 13, and a volume hologram diffraction grating VHG.

In the light focusing device 1 of Example 1, a biconvex lens L1, a spatial filter SF, a biconvex lens L2, a biconvex lens L3, a fixed mirror M, and a biconvex lens L4 were disposed between the polarized beam splitter 12 and the scattering medium 21.

A biconvex lens L5, a polarizer P, and a camera CAM were disposed downstream of the scattering medium 21 as a configuration of the observation system.

In this Example, the following configuration was used. As the laser light source LS, HNL150LB (HeNe laser with output of 15 mW) of Thorlabs was employed. As the two-dimensional light modulator 11, V-7001 (frame rate: 25 kHz) of Vialux, which is an example of the DMD, was employed. In this Example, the number of rows M and the number of columns N of the cell group C were each 360. In addition, a unit for switching in the cell group C when the one-dimensional beam L11 is caused to enter was set to be two columns of cells Cₘₙ. Therefore, the number of columns to be actually scanned was 180 columns. As the cylindrical lens 14, a cylindrical lens having a focal length of 100 mm was employed. As the biconvex lens 15, an achromatic lens having a focal length of 50 mm was employed. As the scanning mirror 16, a CRS (driving frequency: 12 kHz) of Cambridge Technology, which is an example of the resonator mirror, was employed. As the objective lens 17, an objective lens having a magnification of 4 times was employed.

The volume hologram diffraction grating VHG was disposed between the objective lens 17 and the two-dimensional light modulator 11. The volume hologram diffraction grating VHG was arranged for the following purposes. That is, the one-dimensional beam L11 is diffracted by approximately 12 degrees cancel out inclination (approximately) 12°) of micromirrors constituting the respective cells Cₘₙ in the two-dimensional light modulator 11.

The biconvex lenses L1 through L4, which were disposed downstream of the polarized beam splitter 12, were each an achromatic lens. The focal lengths of the biconvex lenses L1 through L4 were 150 mm, 100 mm, 50 mm, and 30 mm.

The spatial filter SF, which was disposed downstream of the biconvex lens L1, allows only light distributed in the vicinity of the optical axis of the two-dimensional beam L22 to pass therethrough, and thus removes unnecessary light included in the two-dimensional beam L22.

The biconvex lens L2, which was disposed downstream of the spatial filter SF, collimates the two-dimensional beam L22 which is dispersed light emitted from the spatial filter SF.

The biconvex lens L3, which was disposed downstream of the biconvex lens L2, converts the two-dimensional beam L22 into convergent light and also forms an image on the reflection surface of the fixed mirror M.

The fixed mirror M, which was disposed downstream of the biconvex lens L3, reflects the two-dimensional beam L22 and thus guides the two-dimensional beam L22 toward the scattering medium 21.

The biconvex lens L4, which was disposed downstream of the fixed mirror M, collimates the two-dimensional beam L22 which is dispersed light reflected by the fixed mirror M, and causes the two-dimensional beam L22 to enter the scattering medium 21.

In Example 1, distributions φ{φ₁,φ₂, . . . φₙ, . . . φ_{N}} in respective columns of the cell group C were set so that a focusing point of the two-dimensional beam L22 could be moved on the focusing surface Pc that was apart from the scattering medium 21 by a constant distance. Specifically, a circle was assumed on the light focusing surface Pc, and eight points were set so as to divide a circumference of the circle into eight equal parts. Each of the distributions On was set using a genetic algorithm so that a focusing point of the two-dimensional beam L22 conforms to any of the eight points. In addition, the distributions φ{φ₁, φ₂, . . . φₙ, . . . φ_{N}} were set so that focusing points were generated at the eight points in a random order. This is to verify random accessibility in moving of the focusing point.

The two-dimensional beams L22 which have been modulated with the distributions φ{φ₁,φ₂, . . . φₙ, . . . φ_{N}} set as describe above were converted into focused light beams by the scattering medium 21 and focused at any of the eight points on the focusing surface Pc.

A focusing pattern of the two-dimensional beam L22 on the light focusing surface Pc was observed using the biconvex lens L5 (focal length: 75 mm), the polarizer P, and the camera CAM, which were the configuration of the observation system.

As Comparative Example for Example 1, distributions φ{φ₁,φ₂, . . . φₙ, . . . φ_{N}} were randomly set in respective columns of the cell group C.

### Example 2 and Example 3

In Example 1, a circle was assumed on the light focusing surface Pc which was 1 cm apart from the scattering medium 21, and eight points were set so as to divide the circumference of the circle into eight equal parts. That is, in Example 1, a main surface of the scattering medium 21 and the light focusing surface Pc were parallel to each other.

Meanwhile, in Example 2, as illustrated in (a) of FIG. 5, the light focusing surface Pc was inclined with respect to the main surface of the scattering medium 21 by an angle θ so that the distance between the light focusing surface Pc and the scattering medium 21 changed monotonically. Furthermore, eight points were set on the focusing surface P_{C} so that a distance between each of the points and the scattering medium 21 monotonically changed. In Example 2 also, each of the distributions On was set using a genetic algorithm so that a focusing point of the two-dimensional beam L22 conforms to any of the eight points.

In Example 3, in order to observe the modulation pattern of the two-dimensional beam L22 as it was, the camera CAM was disposed at a position corresponding to a conjugate plane of the two-dimensional light modulator 11.

In Example 3, as illustrated in (a) of FIG. 6, a distribution in which binary intensities were arranged in an alternating manner was set as a distribution φ₉₀ in a column for which N=90. That is, in cells Cₘ₉₀ where m was an odd number, the intensity was set to 1, and in cells Cₘ₉₀ where m was an even number, the intensity was set to zero. In columns other than N=90, the intensity was set to zero in all cells Cₘₙ.

In Example 3, as the scanning mirror 16, GVS001 of Thorlabs, which is an example of a galvanometer scanner, was employed instead of the CRS of Cambridge Technology, which is an example of the resonator mirror. The galvanometer scanner was employed because the orientation of the reflection surface of the scanning mirror 16 could be controlled in a closed loop.

### Modulation Pattern of Two-Dimensional Beam

Using Example 3, a modulation pattern of the two-dimensional beam L22 was observed. As a result, a modulation pattern of the two-dimensional beam L22 illustrated in (b) of FIG. 6 was obtained.

In the modulation pattern illustrated in (b) of FIG. 6, regions in which intensities were set to 1 and which were distributed as points in the distribution 990 illustrated in (a) of FIG. 6 were stretched in a stripe shape. Therefore, it seemed that the modulation pattern illustrated in (b) of FIG. 6 was generated by stretching the distribution φ₉₀ along the row direction in the second conversion step S13. Therefore, it was found that the spatial light modulation device 10 functioned as designed.

Next, the same binary intensity distributions (φ₁=φ₂= . . . =φₙ= . . . =φ_{N}) were set as distributions of respective columns to be scanned by the two-dimensional light modulator 11, and a modulation pattern of the two-dimensional beam L22 was observed. Cross-correlations between all the distributions φ₁, φ₂, . . . φₙ, . . . φ_{N} were comprehensively obtained, and a graphical representation thereof in a matrix form is illustrated in (c) of FIG. 6.

With reference to (c) of FIG. 6, all the elements of diagonal components were 1 because the diagonal components were autocorrelation values. Meanwhile, cross-correlation values (undiagonal components) between the distributions exhibited an average of 90% or more. From this result, it was found that, by sequentially scanning the columns of the cell group C with the one-dimensional beam L11, modulation using one-dimensional distributions φ{φ₁,φ₂, . . . φₙ, . . . φ_{N}} in respective columns of the two-dimensional light modulator 11 succeeded.

### Generation of Focusing Point by Phase Modulation

Using Example 1 and Comparative Example, the moved focusing point of the two-dimensional beam L22 was observed.

(d) of FIG. 6 is an image indicating an observation result of Comparative Example. When distributions φ{₁,φ₂, . . . φₙ, . . . φ_{N}} in respective columns of the cell group C were randomly set, an image of a speckle pattern was obtained as illustrated in (d) of FIG. 6. The speckle pattern is a pattern that results from random interference in the two-dimensional beam L22.

(e) of FIG. 6 is an image indicating an observation result of Example 1. When distributions φ{φ₁,φ₂, . . . φₙ, . . . φ_{N}} in respective columns of the cell group C were set using a wavefront solution obtained by a genetic algorithm, it was found that a focusing point can be generated as shown in (e) of FIG. 6. The focusing point is a pattern that is obtained as a result of constructive interference in the two-dimensional beam L22.

(f) of FIG. 6 is a graph indicating a peak-to-background ratio (PBR) in each of the columns of the cell group C. The PBR is a ratio (Ip/Ib) of a peak intensity value Ip of a focusing point to an average intensity value Ib of background speckles, and serves as a scale indicating accuracy of spatial light modulation, degree of spatial freedom, and the like. That is, the PBR serves as an index for evaluating quality of a focusing point.

According to (f) of FIG. 6, it was found that the PBR of the focusing point was stably approximately 40 without depending on the column number of the cell group C. From this result, it was found that spatial light modulation with high accuracy could be carried out in all the columns of the cell group C.

### Ultrahigh-Speed Two-Dimensional Light Modulation

Using Example 1 and Example 2, the focusing point of the two-dimensional beam L22 was moved.

(a) of FIG. 7 is a graph indicating column dependency of a frame rate of the light focusing device 1. As illustrated in (a) of FIG. 7, it was found that the frame rate of the light focusing device 1 changed in a sinusoidal manner within a range of approximately 1 MHz to approximately 7 MHz, and that the overall frame rate was approximately 4.3 MHz. This is because, in principle, a motion speed of the resonator scanner employed as the scanning mirror 16 varies in a sinusoidal manner.

In Example 1 and Example 2, frame rates at typical three points (1 MHz, 3 MHz, 6 MHz) were verified. For this purpose, it was desirable to individually observe, on a MHz scale, focusing points which are moved. However, general scientific cameras do not have a frame rate of MHz class. Therefore, in Example 1 and Example 2, acA1440-220 um of Basler was employed as the camera CAM. This camera CAM has an ultrashort exposure mode with an exposure time of 1 μs. By counting the number of focusing points generated during the exposure time of 1 μs, the moving speed of the focusing point, that is, the frame rate of the light focusing device 1 was verified.

In Example 1, (b) of FIG. 7 is an image indicating focusing points generated when the frame rate was 1 MHZ, (c) of FIG. 7 is an image indicating focusing points generated when the frame rate was 3 MHz, and (d) of FIG. 7 is an image indicating focusing points generated when the frame rate was 6 MHz.

Note that the eight red circles shown in (b) through (d) of FIG. 7 correspond to respective eight points defined by assuming a circle on the light focusing surface Pc and dividing the circumference thereof into eight equal parts.

At the frame rate of 1 MHz, two columns of the two-dimensional light modulator 11 are modulated during the exposure time of 1 μs. Therefore, focusing points should be generated at two points out of the eight points. At the frame rate of 3 MHz, four columns of the two-dimensional light modulator 11 are modulated during the exposure time of 1 μs. Therefore, focusing points should be generated at four points out of the eight points. At the frame rate of 6 MHZ, seven columns of the two-dimensional light modulator 11 are modulated during the exposure time of 1 μs. Therefore, focusing points should be generated at seven points out of the eight points.

With reference to (b) through (d) of FIG. 7, it was found that the results as described above were obtained at the frame rates of 1 MHz, 3 MHz, and 6 MHz in Example 1.

In Example 2, (e) of FIG. 7 is an image indicating focusing points generated when the frame rate was 1 MHZ, (f) of FIG. 7 is an image indicating focusing points generated when the frame rate was 3 MHz, and (g) of FIG. 7 is an image indicating focusing points generated when the frame rate was 6 MHz.

Note that the eight red circles shown in (e) through (g) of FIG. 7 correspond to respective eight points which are set on the light focusing surface P_{C} and at each of which a distance from the scattering medium 21 monotonically changes.

With reference to (e) through (g) of FIG. 7, it was found that the results as described above were obtained at the frame rates of 1 MHz, 3 MHz, and 6 MHz also in Example 2, as with the case of Example 1.

From the above results, it has been experimentally demonstrated that the light focusing device 1 can three-dimensionally move a focusing point at a speed of MHz class, in other words, that the light focusing device 1 has a frame rate of MHz class.

Aspects of the present invention can also be expressed as follows:

A spatial light modulation device in accordance with aspect 1 of the present invention includes: a two-dimensional light modulator that includes a cell group in which cells are arranged in a matrix manner and modulation amounts of the respective cells are independently settable; and a scanning optical system that repeatedly carries out a first conversion step, a modulation step, and a second conversion step while changing a column of the cell group which a one-dimensional beam is caused to enter in the modulation step, the first conversion step being a step of converting a two-dimensional beam into a one-dimensional beam, the modulation step being a step of causing the one-dimensional beam obtained in the first conversion step to enter any of columns of the cell group to generate a one-dimensional beam which is spatially modulated in that column, and the second conversion step being a step of converting the one-dimensional beam obtained in the modulation step into a two-dimensional beam.

According to the above configuration, the scanning optical system causes the one-dimensional beam to enter any of columns of the cell group included in the two-dimensional light modulator, and it is thus possible to obtain a two-dimensional beam which is modulated in accordance with a modulation pattern of that column. Furthermore, the scanning optical system can carry out the first conversion step, the modulation step, and the second conversion step on a plurality of columns of the cell group within a period of one frame in the two-dimensional light modulator. Therefore, the frame rate of the spatial light modulation device is higher than that of the two-dimensional light modulator. Therefore, the spatial light modulation device in accordance with aspect 1 can be driven at a frame rate higher than that of the two-dimensional light modulator.

The spatial light modulation device in accordance with aspect 2 of the present invention employs, in addition to the configuration of the spatial light modulation device in accordance with the above described aspect 1, a configuration in which the scanning optical system includes: a cylindrical lens that converts, in the first conversion step, a two-dimensional beam into a one-dimensional beam and that converts, in the second conversion step, a one-dimensional beam into a two-dimensional beam; an objective lens that guides, in the modulation step, the one-dimensional beam to any of columns of the cell group; and a scanning mirror that changes a column of the cell group which the one-dimensional beam is caused to enter in the modulation step.

The above configuration can be suitably used in a case where the two-dimensional light modulator is a reflective type two-dimensional light modulator.

The spatial light modulation device in accordance with aspect 3 of the present invention employs, in addition to the configuration of the spatial light modulation device in accordance with the above described aspect 2, a configuration in which: the two-dimensional light modulator is a digital mirror device; and the scanning mirror is a resonator mirror.

The digital mirror device can be driven at a frame rate on the order of kHz, and the resonator mirror can be driven at a frequency on the order of kHz. Here, assuming that the number of columns in the cell group of the two-dimensional light modulator is N (where N is a positive integer), the two-dimensional light modulator can be, for example, driven at a frame rate (e.g., on the order of MHz) which is 2N times as large as the frequency of the resonator mirror.

The spatial light modulation device in accordance with aspect 4 of the present invention employs, in addition to the configuration of the spatial light modulation device in accordance with the above described aspect 2, a configuration in which: the two-dimensional light modulator is a liquid crystal spatial light modulator; and the scanning mirror is a galvanometer mirror.

The liquid crystal spatial light modulator can be driven at a frame rate on the order of a few hundred hertz, and the galvanometer mirror can be driven at a frequency on the order of a few hundred hertz. Here, assuming that the number of columns in the cell group of the two-dimensional light modulator is N (where N is a positive integer), the two-dimensional light modulator can be, for example, driven at a frame rate (e.g., on the order of a few hundred kilohertz) which is 2N times as large as the frequency of the resonator mirror.

The spatial light modulation device in accordance with aspect 5 of the present invention employs, in addition to the configuration of the spatial light modulation device in accordance with any one of the above described aspects 1 through 4, a configuration of further including: a control section that resets the modulation amounts of the respective cells in the cell group when the one-dimensional beam has been caused to sequentially enter each of all the columns of the cell group in the modulation step.

According to the above configuration, the modulation amounts of the respective cells in the cell group can be updated for each frame. Therefore, the spatial light modulation device in accordance with aspect 5 can continuously generate two-dimensional beams having different modulation patterns.

In order to attain the object, a light focusing device in accordance with aspect 6 of the present invention includes: the spatial light modulation device in accordance with any one of the above described aspects 1 through 5; and a scattering medium that converts the two-dimensional beam obtained in the second conversion step into a focused light beam. In this light focusing device, the configuration is employed in which modulation amounts of respective cells are set so that a position at which a focusing point of the focused light beam is formed varies for each of the columns of the cell group.

According to the above configuration, a plurality of two-dimensional beams which have been generated by the spatial light modulation device and have respective predetermined modulation patterns can be converted into focused light beams using the scattering medium. Focusing points of the focused light beams are formed at different positions. Therefore, the light focusing device in accordance with aspect 6 can move the focusing point of the focused light beam (i.e., carry out scanning) at a frame rate higher than that of the two-dimensional light modulator.

In order to attain the object, a light modulation method in accordance with aspect 7 of the present invention is a light modulation method using a two-dimensional light modulator that includes a cell group in which cells are arranged in a matrix manner and modulation amounts of the respective cells are independently settable. The light modulation method includes: repeatedly carrying out a first conversion step, a modulation step, and a second conversion step while changing a column of the cell group which a one-dimensional beam is caused to enter in the modulation step. In this light modulation method, the first conversion step is a step of converting a two-dimensional beam into a one-dimensional beam, the modulation step is a step of causing the one-dimensional beam obtained in the first conversion step to enter any of columns of the cell group to generate a one-dimensional beam which is spatially modulated in that column, and the second conversion step is a step of converting the one-dimensional beam obtained in the modulation step into a two-dimensional beam.

This light modulation method brings about an effect similar to that of the spatial light modulation device in accordance with aspect 1 of the present invention.

### REFERENCE SIGNS LIST

1: Light focusing device
10: Spatial light modulation device
11: Two-dimensional light modulator
12: Polarized beam splitter
14: Cylindrical lens
15: Biconvex lens
16: Scanning mirror
17: Objective lens
18: Control section
21: Scattering medium
L11, L12: One-dimensional beam
L21, L22: Two-dimensional beam
S11: First conversion step
S12: Modulation step
S13: Second conversion step

1. A spatial light modulation device, comprising:
a two-dimensional light modulator that includes a cell group in which cells are arranged in a matrix manner and modulation amounts of the respective cells are independently settable: and
a scanning optical system that repeatedly carries out a first conversion step, a modulation step, and a second conversion step while changing a column of the cell group which a one-dimensional beam is caused to enter in the modulation step, the first conversion step being a step of converting a two-dimensional beam into a one-dimensional beam, the modulation step being a step of causing the one-dimensional beam obtained in the first conversion step to enter any of columns of the cell group to generate a one-dimensional beam which is spatially modulated in that column, and the second conversion step being a step of converting the one-dimensional beam obtained in the modulation step into a two-dimensional beam.

2. The spatial light modulation device as set forth in claim 1, wherein the scanning optical system includes:
a cylindrical lens that converts, in the first conversion step, a two-dimensional beam into a one-dimensional beam and that converts, in the second conversion step, a one-dimensional beam into a two-dimensional beam:
an objective lens that guides, in the modulation step, the one-dimensional beam to any of columns of the cell group: and
a scanning mirror that changes a column of the cell group which the one-dimensional beam is caused to enter in the modulation step.

3. The spatial light modulation device as set forth in claim 2, wherein:
the two-dimensional light modulator is a digital mirror device; and
the scanning mirror is a resonator mirror.

4. The spatial light modulation device as set forth in claim 2, wherein:
the two-dimensional light modulator is a liquid crystal spatial light modulator; and
the scanning mirror is a galvanometer mirror.

5. The spatial light modulation device as set forth in claim 1, further comprising:
a control section that resets the modulation amounts of the respective cells in the cell group when the one-dimensional beam has been caused to sequentially enter each of all the columns of the cell group in the modulation step.

6. A light focusing device, comprising:
a spatial light modulation device recited in claim 1; and
a scattering medium that converts the two-dimensional beam obtained in the second conversion step into a focused light beam,
modulation amounts of the respective cells being set so that a position at which a focusing point of the focused light beam is formed varies for each of the columns of the cell group.

7. A light modulation method using a two-dimensional light modulator that includes a cell group in which cells are arranged in a matrix manner and modulation amounts of the respective cells are independently settable;
said light modulation method comprising:
repeatedly carrying out a first conversion step, a modulation step, and a second conversion step while changing a column of the cell group which a one-dimensional beam is caused to enter in the modulation step,
the first conversion step being a step of converting a two-dimensional beam into a one-dimensional beam,
the modulation step being a step of causing the one-dimensional beam obtained in the first conversion step to enter any of columns of the cell group to generate a one-dimensional beam which is spatially modulated in that column, and
the second conversion step being a step of converting the one-dimensional beam obtained in the modulation step into a two-dimensional beam.
